(19) United States
(12) Patent Application Publication
(10) Pub. No.: US 2022/0222662 A1
(43) Pub. Date: Jul. 14, 2022

(54) DYNAMIC PAYMENT GATEWAY

(71) Applicant: Wells Fargo Bank, N.A., San Francisco, CA (US)

(72) Inventors: Rameshchandra Bhaskar Ketharaju, Hyderabad (IN); Swapna Gurugubelli, Visakhapatnam (IN); Priyansha Mudaliar, Hyderabad (IN)

(21) Appl. No.: 15/856,515

(22) Filed: Dec. 28, 2017

Related U.S. Application Data
(60) Provisional application No. 62/440,811, filed on Dec. 30, 2016.

(51) Int. Cl. G06Q 20/38; G06Q 50/00; G06Q 20/40; G06Q 30/08

(52) U.S. Cl. CPC G06Q 20/38215; G06Q 50/01; G06Q 20/401; G06Q 30/08; G06Q 20/389

(57) ABSTRACT

The various aspects discussed herein provide business customers with an option to dynamically establish a smart contract with the service provider that is offering the services with the minimum fee for a transaction, or based on other parameters. Block chain technology may be utilized to provide a platform for all service providers to bid for the lowest service fee (or other parameters) for a transaction (or set of transactions). Thus, the business application may launch the service provider that has the lowest bid or lowest service fee at run time.

### CROSS-REFERENCE TO RELATED APPLICATION

This application claims the benefit of U.S. Provisional Patent Application Ser. No. 62/440,811 entitled “DYNAMIC PAYMENT GATEWAY” filed on Dec. 30, 2016. The entirety of the above-noted application is incorporated by reference herein.

### BACKGROUND

The use of internet technology to perform many functions that were traditionally performed in-person has become common. For various services, a service provider is selected to provide a defined function. For example, an e-commerce application service provider may be selected to provide merchant services. After selection of the e-commerce application service provider, that provider is used for all merchant related services. If a new e-commerce application service provider is selected, that new provider is then used for all the merchant related services. However, being locked into a contract with the currently selected service provider may result in undesired consequences, including higher costs.

### SUMMARY

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

The various aspects provided herein are related to a dynamic payment gateway model. In an example, a customer initiates a request for a service over the Internet. Before the request reaches the service provider, the request traverses over a block chain of service providers. It will query information in a public ledger and identify the service provider with minimal service charge (or other criteria) and establishes a smart contract with that particular service provider. The customer request will be fulfilled by the identified service provider.

An aspect relates to a system that includes a processor and a memory that stores executable instructions that, when executed by the processor, facilitate performance of operations. The operations include receiving a request for a service. The request is received over an Internet connection and is based on a website that includes the service. The operations may also include traversing a block chain interface that comprises a set of providers. Providers in the set of providers are capable of fulfilling the service. The operations may also include evaluating each provider in the set of providers based on a public ledger that includes respective information associated with each provider. Further, the operations may include selecting a provider from the set of providers based on the evaluating and establishing a smart contract with the selected provider. The smart contract provides for fulfilment of the service.

Another aspect relates to a method that includes receiving, by a system comprising a processor, a request for a service from a purchaser. The request is received over an Internet connection and is based on a website that includes the service. The method also includes traversing, by the system, a block chain interface that comprises a set of providers, wherein providers in the set of providers are capable of fulfilling the service. Further, the method includes ranking, by the system, each provider in the set of providers based on a public ledger that includes respective information associated with each provider. The method also includes selecting, by the system, a provider from the set of providers based on the ranking and establishing, by the system, a smart contract with the selected provider, the smart contract provides for the fulfilment of the service.

Yet another aspect relates to a computer-readable storage device that stores executable instructions that, in response to execution, cause a system comprising a processor to perform operations. The operations include traversing a block chain interface that comprises a set of providers based on a request for a service. The request is received over an Internet connection and is based on a website that includes the service, and the providers included in the set of providers are capable of fulfilling the service. The operations also include ranking each provider in the set of providers based on a public ledger that includes respective information associated with each provider. Further, the operations include selecting a provider from the set of providers based on the ranking and establishing a smart contract with the selected provider. The smart contract provides for the fulfilment of the service.

To the accomplishment of the foregoing and related ends, certain illustrative aspects of the innovation are described herein in connection with the following description and the annexed drawings. These aspects are indicative, however, of but a few of the various ways in which the principles of the innovation may be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

Various non-limiting embodiments are further described with reference to the accompanying drawings in which:

FIG. 1 illustrates an example, non-limiting system configured to provide a dynamic payment gateway, according to an aspect;

FIG. 2 illustrates an example, non-limiting system configured to provide an open platform for multiple service providers to compete to fulfill one or more services, according to an aspect;

FIG. 3 illustrates an example, non-limiting system that employs automated learning to facilitate one or more of the disclosed aspects;

FIG. 4 illustrates an example, non-limiting flow diagram for a use case scenario, according to an aspect;

FIG. 5 illustrates an example, non-limiting flow diagram for another use case scenario, according to an aspect;

FIG. 6 illustrates an example, non-limiting flow diagram for a further use case scenario, according to an aspect;

FIG. 7 illustrates an example, non-limiting system illustrating the use case example of FIG. 6, according to an aspect;

FIG. 8 illustrates an example, non-limiting computer-readable medium or computer-readable device including processor-executable instructions configured to embody one or more of the aspects set forth herein; and

FIG. 9 illustrates an example, non-limiting computing environment where one or more of the aspects set forth herein are implemented, according to one or more aspects.

### DETAILED DESCRIPTION

The innovation is now described with reference to the drawings. In the following description, for purposes of explanation, numerous specific details are set forth in order to provide a thorough understanding of the subject innovation. It may be evident, however, that the innovation may be practiced without these specific details. In other instances, well-known structures and devices are shown in block diagram form in order to facilitate describing the innovation.

Various aspects described herein relate to a dynamic payment gateway. Once an e-commerce application service provider is selected that provider is used for all merchant related services until another merchant is chosen. This strong coupling between the retail business applications and service providers do not allow the business applications to choose between profitable options amongst the service providers.

The various aspects discussed herein provide business customers with an option to dynamically establish a smart contract with the service provider that is offering the services with the minimum fee for a transaction. The system may utilize block chain technology, which may be used by all business applications. The block chain technology may provide a platform for all service providers to bid for the lowest service fee for a transaction (or set of transactions). Thus, the business application may launch the service provider that has the lowest bid or lowest service fee at run time.

In an additional or alternative aspect, business customers may be provided with an option to dynamically establish a smart contract with a financial entity which may offer the services with the minimum fee for a transaction on the merchant's account through the payment gateway.

As used herein an “entity” or “financial entity” refers to a financial institution, such as a bank, persons operating on behalf of the financial institution, and/or communication devices managed by the financial institution and/or the persons operating on behalf of the financial institution. Additionally or alternatively, the entity may be a third party monitoring source or another type of entity that has a trusted relationship with the financial institution.

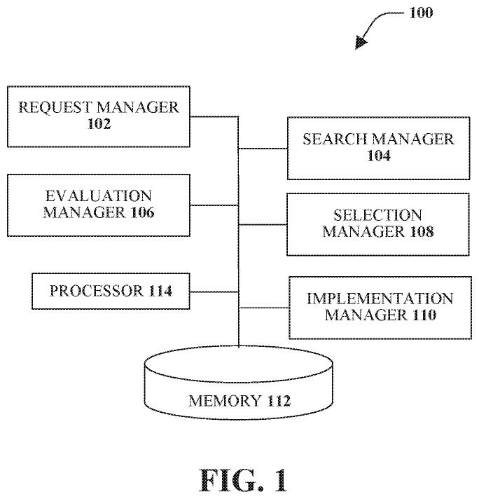

FIG. 1 illustrates an example, non-limiting system 100 configured to provide a dynamic payment gateway, according to an aspect. They system 100 (as well as other aspects discussed herein) provides an open platform based on block-chain technology. The open platform allows multiple service providers to compete for lowest price for services. Further, the block-chain technology may provide a public ledger that may be used by all business customers to view various transactions and arrive at a consensus of the most profitable service provider that is available.

The system 100 includes a request manager 102 that may be configured to receive one or more requests for one or more services. The request(s) may be received over an Internet connection and may be based on a website that includes the service. For example, the website may be a shopping website, a website associated with a financial entity, or another website through which various products and/or services (referred to simply as services) may be requested.

Also included in the system 100 is a search manager 104 that may be configured to traverse a block-chain interface that includes a set of providers that are capable of fulfilling the service. A block-chain is a distributed database that maintains an ongoing (or active) list of records, referred to as blocks. In the various aspects discusses herein, the list of records includes service providers, the services offered by each of these providers, historical pricing data, and other information related to the provider and/or the service.

An evaluation manager 106 may be configured to evaluate each provider in the set of providers based on a public ledger. The public ledger may include respective information associated with each provider in the set of providers. For example, the respective information may include respective historical information, current information, and/or solicited information for each provider. The historical information may include customer ranking information associated with the provider. In another example, the historical information may include previous dealing with the provider. In yet another example, the historical information may include details of a smart contract previously negotiated between the provider and a host of the website. The current information may include a quantity of products currently available, timing related to providing the requested service, and other real-time information. The solicited information may include information received in response to a request for each provider to bid on fulfillment of the service (e.g., an open bidding process).

A selection manager 108 may be configured to select one of the providers for fulfillment of the requested service. The selection manager 108 may select the provider based on a ranking order or other means of distinguishing the providers. For example, a provider that is a lowest bidder may be selected. If two providers submit the lowest bid, the selection manager 108 may utilize additional information to select from among the lowest bidders. The additional information may include the historical information, the current information, and/or the solicited information. According to some implementations, the additional information may include conformance to one or more parameters requested by the purchaser (e.g., an available quantity of items, a delivery time, and so on).

An implementation manager 110 may be configured to establish a smart contract with the selected provider. According to some implementations, the smart contract is already established (e.g., predefined) and the implementation manager 110 activates the smart contract. The smart contract provides for fulfillment of the service by the selected provider as well as other details related to the transaction.

The system 100 may include at least one memory 112 that may store computer executable components and/or computer executable instructions. The system 100 may also include at least one processor 114, communicatively coupled to the at least one memory 112. The at least one processor 114 may facilitate execution of the computer executable components and/or the computer executable instructions stored in the at least one memory 112. The term “coupled” or variants thereof may include various communications including, but not limited to, direct communications, indirect communications, wired communications, and/or wireless communications.

It is noted that although the one or more computer executable components and/or computer executable instructions may be illustrated and described herein as components and/or instructions separate from the at least one memory 112 (e.g., operatively connected to the at least one memory 112), the various aspects are not limited to this implementation. Instead, in accordance with various implementations, the one or more computer executable components and/or the one or more computer executable instructions may be stored in (or integrated within) the at least one memory 112. Further, while various components and/or instructions have been illustrated as separate components and/or as separate instructions, in some implementations, multiple components and/or multiple instructions may be implemented as a single component or as a single instruction. Further, a single component and/or a single instruction may be implemented as multiple components and/or as multiple instructions without departing from the example embodiments.

The various aspects may be configured to switch to the most profitable payment gateway dynamically. In some implementations, the switch may be to the most profitable bank with seller account dynamically. The identified profitable payment gateway is launched. Further, a smart contract is dynamically established with the payment gateway which is offering the services with the minimum fee for a transaction. The various aspects may be used by all e-commerce service providers which will provide a platform for all payment gateways to bid for the lowest service fee for a transaction (or set of transactions). In such a manner, the e-commerce application may launch the payment gateway which has the lowest bid or lowest service fee at run time. Further, the various aspects may dynamically establish a smart contract with the bank that is offering the services with the minimum fee for a transaction on the merchant's account through payment gateway.

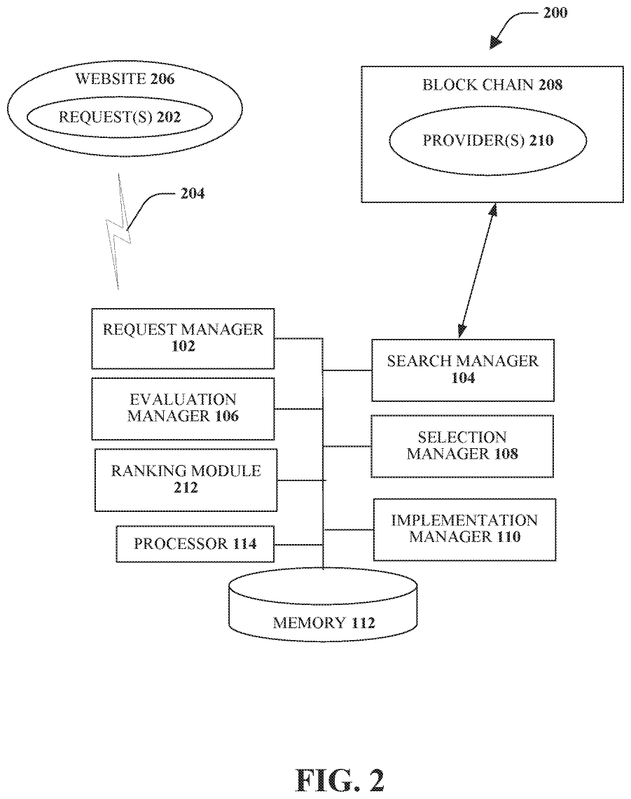

FIG. 2 illustrates an example, non-limiting system 200 configured to provide an open platform for multiple service providers to compete to fulfill one or more services, according to an aspect. The various aspects provided herein utilize a block chain technology concept where a transparent open negotiation platform may be established between service providers and business customers. The transactions between service providers and business customers may be made accessible to everyone through a public ledger and, therefore, business customers may understand the underlying transactional charges. This may facilitate negotiation between different service providers in the market and may identify the most profitable service provider for their business. This may also lead to a decentralized consensus between the service providers and business customers over the service charges.

As illustrated, a request 202 for a service is received over an Internet connection 304 by a request manager 102 that may be configured to receive one or more requests for one or more services. The request(s) may be received over an Internet connection and may be based on a website 206 that includes the service. For example, the website may be a shopping website, a website associated with a financial entity, or another website through which various products and/or services (referred to simply as services) may be requested. As noted, the service is included in a website 206 (e.g., an internet commerce website, a financial services website, or another type of website). According to some implementations, the service is a payment gateway service. In this implementation, the payment gateway is used to purchase one or more items through the website.

Based on the request, the search manager 104 traverses a block chain 208 that includes a set of providers 210 that may provide the service. The search manager 104 may request a bid for the service from each provider in the set of providers. In some implementations, the block chain 208 may include a combination of providers that may provide the service as well as other providers. In an example, the set of providers may be payment gateways. In another example, the set of providers may be a set of financial providers. In yet another example, the set of providers may be merchants, and so on.

According to an implementation, the block chain 208 is a transparent, open negotiation platform. The block chain 208 may be established between two or more parties, such as between a service provider and a business customer. In accordance with another implementation, the block chain 208 is accessible by the set of providers 210. This may be facilitated in order to negotiate between the service provider in the market and may be utilized to identify the most profitable service provider for the business. This may also lead to a decentralized consensus between the service provider and the business customer for what the service charges for fulfillment of the service.

The evaluation manager 106 reviews the details related to each provider in the set of providers 210. According to some implementations, a ranking module 212 may be configured to rank each provider based on a cost to fulfill the service (e.g., the lowest cost providers). In another implementation, the ranking module 212 may be configured to rank each provider based on meeting or exceeding a defined parameter related to the service. For example, the defined parameter may be the lowest cost provider, however, the disclosed aspects are not limited to this implementation. Instead, the defined parameters (or more than one parameter) may be defined as what is important to the purchaser (e.g., the quantity of desired items available immediately, a shipment time, and so on).

Based on the evaluation and/or the ranking, the selection manager 108 chooses one of the providers and the implementation manager 110 establishes a smart contract with the selected provider. The smart contract provides for the fulfilment of the service. Further, the smart contract may be pre-negotiated between the selected provider and a host of the website.

The purchase may be completed based on an interaction with the selected provider. According to some implementations, the selection of the provider may include the provider offering an incentive for a repeat purchase (e.g., if you purchase from this provider a second time, you will get a 5% discount). In other implementations, the provider may offer an incentive based on a social network strength (e.g., a number of contacts being more than a threshold number, the purchasing being active on the social network, and so on). Further, additional incentives may be provided based on purchases received from members of a defined social network.

Accordingly, a customer may choose the vendor/merchant who is offering the best price for the product. The aggregator (e.g., commerce website) may switch to the payment gateway with minimal service fee and thus establishes a profitable deal at runtime. Banks and/or other financial entities may participate in the open negotiation platforms and may earn profits (the savings and/or other incentives may be also provided to the individual consumer). Further, with the disclosed aspects there are no hidden service contracts with the customer and the service provider. The transparent negotiations and competitive platform may provide services at the best available prices. The various aspects also provide an opportunity for small scale service providers to make a mark in their respective industry. Business growth opportunity by making use of the information available in public domain may also be provided.

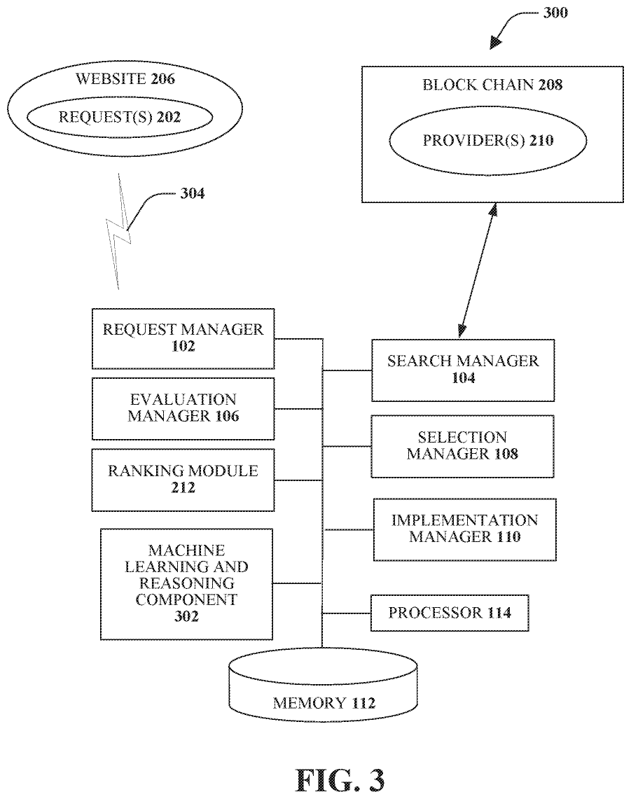

FIG. 3 illustrates an example, non-limiting system 300 that employs automated learning to facilitate one or more of the disclosed aspects. The various aspects provided herein provide that customers will no longer be forced to get service from only one service provider due to the strong coupling between business applications and service provider applications. Further, the various aspects allows the customer to choose among the profitable options. The various aspects also provides that the contract between the customer and service providers is transparent and efficient and provides an open platform for all the service providers in the market.

A machine learning and reasoning component 302 may be utilized to automate one or more of the disclosed aspects. The machine learning and reasoning component 302 may employ automated learning and reasoning procedures (e.g., the use of explicitly and/or implicitly trained statistical classifiers) in connection with performing inference and/or probabilistic determinations and/or statistical-based determinations in accordance with one or more aspects described herein.

For example, the machine learning and reasoning component 302 may employ principles of probabilistic and decision theoretic inference. Additionally or alternatively, the machine learning and reasoning component 302 may rely on predictive models constructed using machine learning and/or automated learning procedures. Logic-centric inference may also be employed separately or in conjunction with probabilistic methods.

The machine learning and reasoning component may infer how providers should be ranked or prioritized in comparison to other providers, which providers to invite to respond to a request for a service (e.g., to bid), whether a ranked score for a provider should be changed based on one or more defined parameters related to the service, and so on. Based on this knowledge, the machine learning and reasoning component 302 may make an inference based on the defined parameters, results of a bidding process, a smart contract, and so on.

As used herein, the term “inference” refers generally to the process of reasoning about or inferring states of the system, a component, a module, the environment, customers or purchasers, providers (or devices associated with the customers and/or providers) from a set of observations as captured through events, reports, data, and/or through other forms of communication. Inference may be employed to identify a specific context or action, or may generate a probability distribution over states, for example. The inference may be probabilistic. For example, computation of a probability distribution over states of interest based on a consideration of data and/or events. The inference may also refer to techniques employed for composing higher-level events from a set of events and/or data. Such inference may result in the construction of new events and/or actions from a set of observed events and/or stored event data, whether or not the events are correlated in close temporal proximity, and whether the events and/or data come from one or several events and/or data sources. Various classification schemes and/or systems (e.g., support vector machines, neural networks, logic-centric production systems, Bayesian belief networks, fuzzy logic, data fusion engines, and so on) may be employed in connection with performing automatic and/or inferred action in connection with the disclosed aspects.

The various aspects (e.g., in connection with facilitating a dynamic payment gateway) may employ various artificial intelligence-based schemes for carrying out various aspects thereof. For example, a process for determining a ranking of a particular provider, a lowest cost bidder from a set of bidders that provide a requested service, and so on may be enabled through an automatic classifier system and process.

A classifier is a function that maps an input attribute vector, x=(x1, x2, x3, x4, xn), to a confidence that the input belongs to a class. In other words, f(x)=confidence(class). In aspects, this could be trained by the innovation as described herein as well as having edge analytic capabilities that understand social strength or the like. Such classification may employ a probabilistic and/or statistical-based analysis (e.g., factoring into the analysis utilities and costs) to prognoses or infer an action that should be employed to determine what transactions should be automatically allowed, which transactions should be sent out for bid, and so on. In the case of a dynamic payment gateway, for example, attributes may be a type of service requested and the classes may be identification of a parameter that matches a requested parameter.

A support vector machine (SVM) is an example of a classifier that may be employed. The SVM operates by finding a hypersurface in the space of possible inputs, which hypersurface attempts to split the triggering criteria from the non-triggering events. Intuitively, this makes the classification correct for testing data that may be similar, but not necessarily identical to training data. Other directed and undirected model classification approaches (e.g., naïve Bayes, Bayesian networks, decision trees, neural networks, fuzzy logic models, and probabilistic classification models) providing different patterns of independence may be employed. Further, other aspects can include, but are not limited to alternative statistical models as well as IoT (Internet of Things), edge analytic capabilities or the like. Classification as used herein may be inclusive of statistical regression that is utilized to develop models of priority.

One or more aspects may employ classifiers that are explicitly trained (e.g., through a generic training data) as well as classifiers that are implicitly trained (e.g., by observing behavior, by receiving extrinsic information, and so on). For example, SVM's may be configured through a learning or training phase within a classifier constructor and feature selection module. Thus, a classifier(s) may be used to automatically learn and perform a number of functions, including but not limited to determining according to a predetermined criteria which transactions may be processed automatically based on historical data related to the same or a similar event, which providers should be contacted to bid on one or more transactions, whether to open the bid to additional providers (e.g., a newly identified provider), whether the transaction was resolved satisfactorily, and so forth. The criteria may include, but is not limited to, similar transactions, historical information, current information, transaction attributes, and so forth.

Additionally or alternatively, an implementation scheme (e.g., a rule, a policy, and so on) may be applied to control and/or regulate which transactions are considered to be routine and most likely do not need to be sent out for bidding from various providers. In some implementations, based upon a predefined criterion, the rules-based implementation may automatically and/or dynamically interpret attributes associated with each transaction. In response thereto, the rule-based implementation may automatically interpret and carry out functions associated with the transactions by employing a predefined and/or programmed rule(s) based upon any desired criteria.

Methods that may be implemented in accordance with the disclosed subject matter, will be better appreciated with reference to the following flow diagrams. While, for purposes of simplicity of explanation, the methods are shown and described as a series of blocks, it is to be understood and appreciated that the disclosed aspects are not limited by the number or order of blocks, as some blocks may occur in different orders and/or at substantially the same time with other blocks from what is depicted and described herein. Moreover, not all illustrated blocks may be required to implement the disclosed methods. It is to be appreciated that the functionality associated with the blocks may be implemented by software, hardware, a combination thereof, or any other suitable means (e.g. device, system, process, component, and so forth). Additionally, it should be further appreciated that the disclosed methods are capable of being stored on an article of manufacture to facilitate transporting and transferring such methods to various devices. Those skilled in the art will understand and appreciate that the methods might alternatively be represented as a series of interrelated states or events, such as in a state diagram.

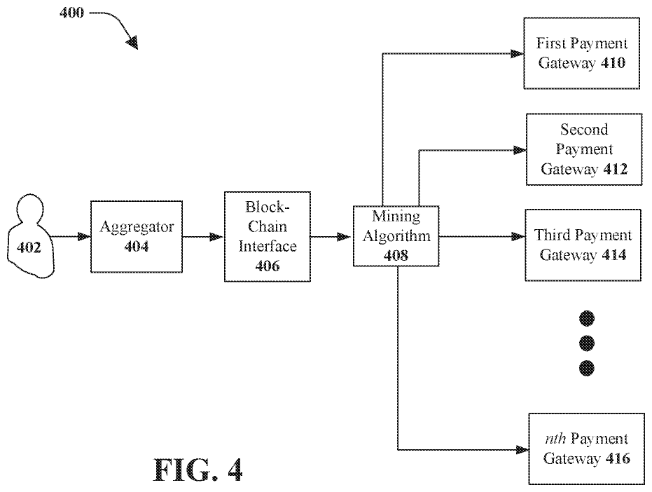

FIG. 4 illustrates an example, non-limiting flow diagram 400 for a use case scenario, according to an aspect. According to this use case scenario, business customers trading in products/services may utilize the various aspects herein to dynamically contract with a payment gateway using Internet resources. For example, the determination of the payment gateway to select may be based on the gateway that is offering the lowest service fee.

As illustrated a customer 402 places an order through an e-commerce website 404 (e.g., an aggregator). At about the same time as the customer 402 selects a payment option and before a payment gateway is launched, a block chain interface 406 is traversed. The block chain interface 406 may include a robot algorithm with machine intelligence (e.g., a mining algorithm 408, the machine learning and reasoning component 302 of FIG. 3, and so on) that may be configured to traverse over the block chain and determine potential bidders. In this example, the potential bidders are identified as payment gateways and labeled as a first payment gateway 410, a second payment gateway 412, a third payment gateway 414, through an n-th payment gateway 416, where n is an integer.

At about the same time as the payment gateway that offers the service with the least expensive service fee (e.g., minimal service fee) is identified, a smart contract is established. At about the same time as the smart contract is accepted, the request from the customer 402 will redirect to the selected payment gateway. The payment request is submitted to the identified payment gateway, the transaction completes, and the order is placed. It is noted that the identification of the payment gateway and establishment of the smart contract occurs seamlessly and within a matter of seconds.

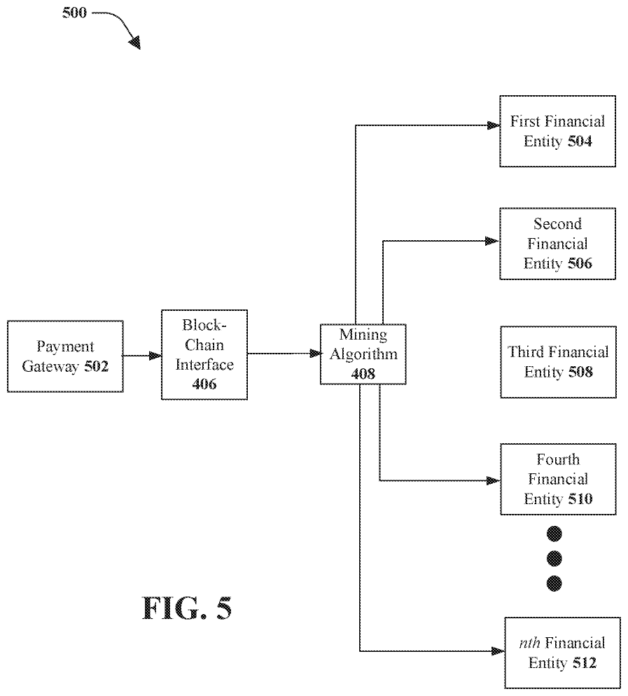

FIG. 5 illustrates an example, non-limiting flow diagram 500 for another use case scenario, according to an aspect. This example may be used by business customers trading in products or services using the Internet to dynamically contract with a financial entity that is offering the lowest service fee for a seller's account.

A customer (not shown) places an order at an e-commerce website. At about the same time as the customer choses the payment options and before the payment gateway 502 is launched, the flow will reach to the block chain interface 406. The block chain interface may comprise a robot algorithm with machine intelligence 408 to traverse over the block chain and look for all the potential bidders. In this example, the potential bidders are financial entities, illustrated as a first financial entity 504, a second financial entity 506, a third financial entity 508, a fourth financial entity 510, through an n-th financial entity 512, where n is an integer.

At about the same time as the financial entity with minimal service fee is identified, a smart contract is established with that financial entity which is not necessarily the seller's account bank. Accordingly, the disclosed aspects provide an open platform to multiple financial entities to compete for merchant accounts.

At about the same time as the smart contract is accepted, the request (from the customer) will redirect to that financial entity. The payment request is submitted to the payment gateway 502 with the identified seller's account and the transaction completes and the order will be placed. The identification of the most profitable bank account and establishment of smart contract will happen within few seconds.

Another non-limiting use case example relates to use by the customer to identify the merchant who may offer best price for the product and/or service. In this example, an active shopper is in pursuit of purchasing something from an e-commerce website. The shopper (e.g., customer) in this case is the miner that will be traversing over the block chain of all the potential vendors/merchants who have the product/service desired to be purchased.

The shopper will choose an e-commerce portal which will directly interact to the block chain interface, which will traverse over the block chain and identify the merchant with best price for the product. In this case, the traversal over block chain does not have to finish within a few seconds. Instead, the shopper may invest time for the best price. At about the same time as the product is identified, the shopper may place the order through the aggregator.

Still another non-limiting use case may be used between and individual consumer and an aggregator (e.g., a business customer). The aggregator may provide the best price for the consumer by reviewing the consumer's social network with the expectation that the consumer will send the purchase notification to his/her social network groups.

In this example, an active shopper is in pursuit of purchasing something from an e-commerce website. The e-commerce aggregator will traverse over the block chain to understand the shopper's social network strength. If the shopper has a good network, then the aggregator may offer the best price for the product with the condition that the purchase details will be shared across his/her social network groups.

According to some implementations, if the aggregator is receiving orders through the customer's social network then it may provide concessions (e.g., incentives) to the customer. However, if the aggregator is not receiving enough orders through customer's social network, it may reduce the concession it is offering to the customer. The aggregator, through the block chain, may identify the customers who have a network of people with an identified spending need/desire. In this example, the concession may be provided later, which does not require a high speed algorithm for block chain traversal.

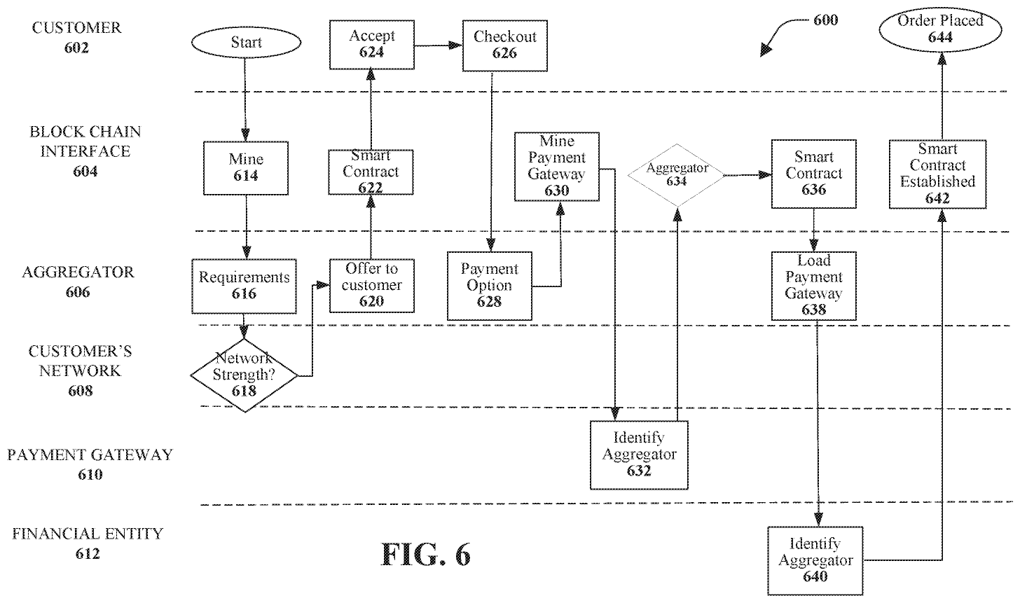

FIG. 6 illustrates an example, non-limiting flow diagram 600 for a further use case scenario, according to an aspect. The flow diagram 600 is an end to end use case from customer to merchant to the payment gateway selection. The dotted lines indicate different entities involved in the dynamic payment gateway. At the top (horizontally) are the activities performed by the customer 602. Next are the activities performed by the block chain interface 604 and the aggregator 606. The customer's network 608 is also illustrated. Further, illustrated are the activities performed by the payment gateway 610 and the financial entity 612.

In this example, an active shopper (e.g., customer 602) is in pursuit of purchasing something from an e-commerce website (e.g., the aggregator 606). The shopper will be the miner who will be traversing (e.g., mine 614) over the block chain (e.g., the block chain interface 604) of all the potential vendors/merchants who have the product he/she desires to purchase with the selected criteria. The criteria may be the best price or may be another criteria such as desired quantity in stock, shipping terms, product location, and so on.

The shopper will choose an e-commerce portal which will directly interact to the block chain interface 604 and will traverse all over the block chain to identify the customer and the customer's requirements 616. Further, the e-commerce portal will determine 618 the social network strength of the customer's network 608.

Once the customer selects the merchant and a smart contract is established, the merchant may choose to give the customer a concession on the product by looking at the customer's social network of friends. A determination may be made whether the customer has a good social network. This determination may be made based on predefined parameters, which may include, a quantity of contacts, an activity level on the social network, and so on.

The merchant may provide a discount or concession 620 (e.g., offer a best price to the customer) if the customer's social group is huge, for example. In some implementations, there may not be any discount provided. A smart contract 622 will be established with the best price on the product. According to some implementations, the smart contract may include the condition that the customer will send notification of the purchase (e.g., merchant details and other information) to the social group. According to some implementations, the merchant may decide to reward the customer with further discounts or concessions on future purchases if the people in customer's social network start placing orders.

After the product is selected on merchant's ecommerce website (e.g., the customer takes the offer 624), the customer proceeds to the checkout 626. For checkout, the customer choses a payment option 628 and the block chain interface will be launched again in the background to mine for the payment gateway 630.

Upon payment gateway selection, financial entities (e.g., banks) may act as miners and start mining for projected possible transactions on the merchant's account so that the financial entity may offer a minimal service fee. Thus, an aggregator may be identified 632 and the block chain interface may determine the aggregator that has a large potential for transactions 634. Further, a robot algorithm with machine intelligence may traverse over the block chain and look for the bank with minimal service fee. Once a potential bidder is identified, a smart contract will be established with that bank 636, which may not necessarily be the seller's bank.

A similar algorithm may be used to select the payment gateway dynamically 638 and the aggregator may be identified 640. The payment gateways might also be mining and speculating the number of transactions that may go through at the merchant's website to offer the minimal service fee.

The algorithm will traverse over the block chain of the payment gateway and look for the payment gateway with minimal service fee.

Once a potential bidder is identified, a smart contract will be established 642 with that payment gateway, which will be launched dynamically. The use case will end when the payment is successful and the order is placed 644. Further, the flow, from the start to the placement of the order will occur within seconds (e.g., in real-time).

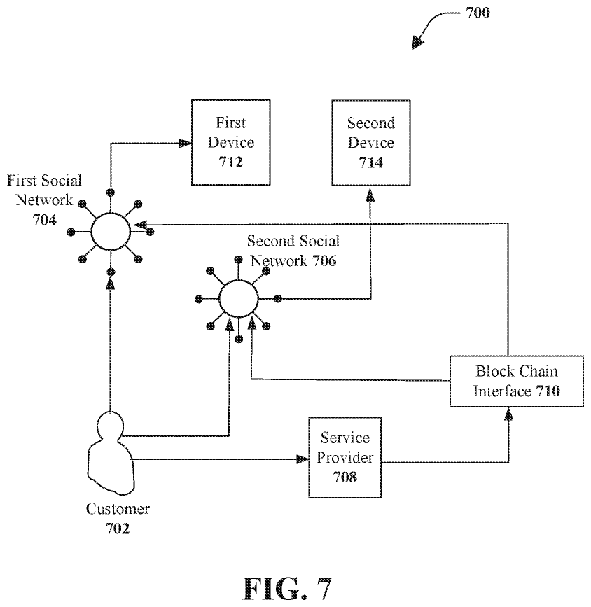

FIG. 7 illustrates an example, non-limiting system 700 illustrating the use case example of FIG. 6. As illustrated, a customer 702 may have one or more social networks, illustrated as a first social network 704 and a second social network 706. When the customer 702 desires to purchase a product and/or service from a service provider 708, the service provider 708 may utilize a block chain interface 710 to obtain the product/service that conforms to one or more defined parameters. For example, a defined parameter may be a lowest cost. In another example, the defined parameter may be a fastest delivery time. In yet another example, the defined parameter may be a local provider. In still another example, the defined parameter may be a specific quantity available (without backorder).

At about the same time as the block chain interface 710 identifies the gateway or other provider, the order is completed. As illustrated the block chain interface 710 may notify respective contacts of the customer 702 within the first social network 704 and/or the second social network 706. Thus, contacts of the social networks will receive the information of their respective devices, illustrated as a first device 712 and a second device 714.

The information provided on the first device 712, the second device 714, and other devices may include information related to the customer 702, the service provider 708, the item purchased, and other information. Additionally, an enticement may be provided to the contacts for them to purchase the same or similar product from the service provider 708. The enticement may include a discount, a promotion special, or another incentive.

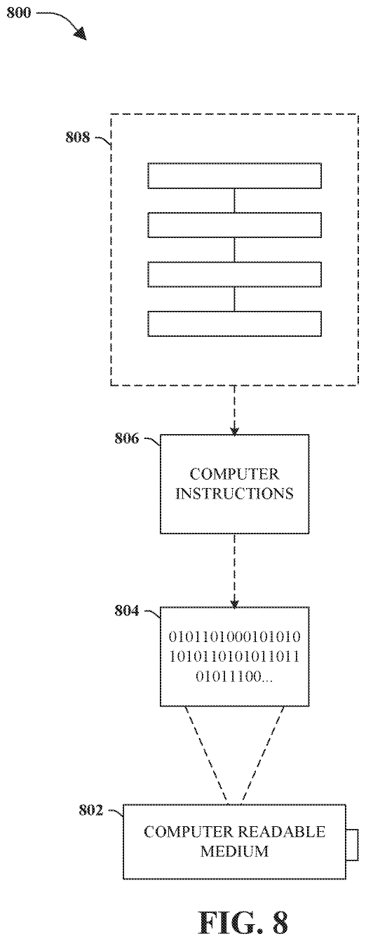

One or more implementations include a computer-readable medium including microprocessor or processor-executable instructions configured to implement one or more embodiments presented herein. As discussed herein the various aspects enable a dynamic payment gateway model. An embodiment of a computer-readable medium or a computer-readable device devised in these ways is illustrated in FIG. 8, wherein an implementation 800 includes a computer-readable medium 802, such as a CD-R, DVD-R, flash drive, a platter of a hard disk drive, and so forth, on which is encoded computer-readable data 804. The computer-readable data 804, such as binary data including a plurality of zero's and one's as illustrated, in turn includes a set of computer instructions 806 configured to operate according to one or more of the principles set forth herein.

In the illustrated embodiment 800, the set of computer instructions 806 (e.g., processor-executable computer instructions) may be configured to perform a method 808, such as the method 400 of FIG. 4 and/or the method 600 of FIG. 6, for example. In another embodiment, the set of computer instructions 806 may be configured to implement a system, such as the system 100 of FIG. 1 and/or the system 300 of FIG. 3, for example. Many such computer-readable media may be devised by those of ordinary skill in the art that are configured to operate in accordance with the techniques presented herein.

As used in this application, the terms “component,” “module,” “system,” “interface,” “manager,” and the like are generally intended to refer to a computer-related entity, either hardware, a combination of hardware and software, software, or software in execution. For example, a component may be, but is not limited to being, a process running on a processor, a processor, an object, an executable, a thread of execution, a program, or a computer. By way of illustration, both an application running on a controller and the controller may be a component. One or more components residing within a process or thread of execution and a component may be localized on one computer or distributed between two or more computers.

Further, the claimed subject matter may be implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

FIG. 8 and the following discussion provide a description of a suitable computing environment to implement embodiments of one or more of the aspects set forth herein. The operating environment of FIG. 8 is merely one example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, and the like, multiprocessor systems, consumer electronics, mini computers, mainframe computers, distributed computing environments that include any of the above systems or devices, etc.

Generally, embodiments are described in the general context of “computer readable instructions” being executed by one or more computing devices. Computer readable instructions may be distributed via computer readable media as will be discussed below. Computer readable instructions may be implemented as program modules, such as functions, objects, Application Programming Interfaces (APIs), data structures, and the like, that perform one or more tasks or implement one or more abstract data types. Typically, the functionality of the computer readable instructions are combined or distributed as desired in various environments.

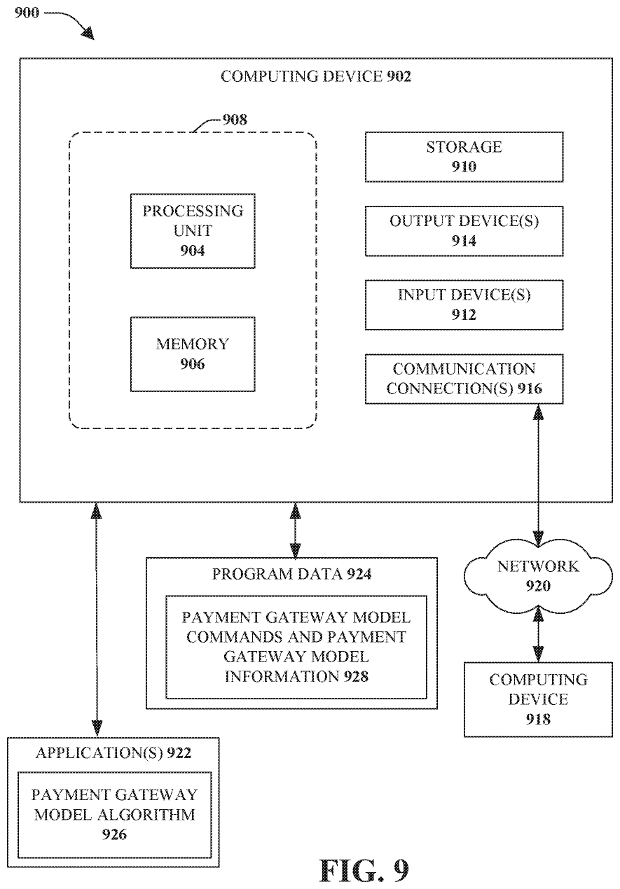

FIG. 9 illustrates a system 900 that may include a computing device 902 configured to implement one or more embodiments provided herein. In one configuration, the computing device 902 may include at least one processing unit 904 and at least one memory 906. Depending on the exact configuration and type of computing device, the at least one memory 906 may be volatile, such as RAM, non-volatile, such as ROM, flash memory, etc., or a combination thereof. This configuration is illustrated in FIG. 9 by dashed line 908.

In other embodiments, the computing device 902 may include additional features or functionality. For example, the computing device 902 may include additional storage such as removable storage or non-removable storage, including, but not limited to, magnetic storage, optical storage, etc. Such additional storage is illustrated in FIG. 9 by storage 910. In one or more embodiments, computer readable instructions to implement one or more embodiments provided herein are in the storage 910. The storage 910 may store other computer readable instructions to implement an operating system, an application program, etc. Computer readable instructions may be loaded in the at least one memory 906 for execution by the at least one processing unit 904, for example.

Computing devices may include a variety of media, which may include computer-readable storage media or communications media, which two terms are used herein differently from one another as indicated below.

Computer-readable storage media may be any available storage media, which may be accessed by the computer and includes both volatile and nonvolatile media, removable and non-removable media. By way of example, and not limitation, computer-readable storage media may be implemented in connection with any method or technology for storage of information such as computer-readable instructions, program modules, structured data, or unstructured data. Computer-readable storage media may include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which may be used to store desired information. Computer-readable storage media may be accessed by one or more local or remote computing devices (e.g., via access requests, queries or other data retrieval protocols) for a variety of operations with respect to the information stored by the medium.

Communications media typically embody computer-readable instructions, data structures, program modules, or other structured or unstructured data in a data signal such as a modulated data signal (e.g., a carrier wave or other transport mechanism) and includes any information delivery or transport media. The term “modulated data signal” (or signals) refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

The computing device 902 may include input device(s) 912 such as keyboard, mouse, pen, voice input device, touch input device, infrared cameras, video input devices, or any other input device. Output device(s) 914 such as one or more displays, speakers, printers, or any other output device may be included with the computing device 902. The input device(s) 912 and the output device(s) 914 may be connected to the computing device 902 via a wired connection, wireless connection, or any combination thereof. In one or more embodiments, an input device or an output device from another computing device may be used as the input device(s) 912 and/or the output device(s) 914 for the computing device 902. Further, the computing device 902 may include communication connection(s) 916 to facilitate communications with one or more other devices, illustrated as a computing device 918 coupled over a network 920.

One or more applications 922 and/or program data 924 may be accessible by the computing device 902. According to some implementations, the application(s) 922 and/or program data 924 are included, at least in part, in the computing device 902. The application(s) 922 may include a payment gateway model algorithm 926 that is arranged to perform the functions as described herein including those described with respect to the system 300 of FIG. 3. The program data 924 may include payment gateway model commands and payment gateway model information 928 that may be useful for operation with the various aspects as described herein.

Although the subject matter has been described in language specific to structural features or methodological acts, it is to be understood that the subject matter of the appended claims is not necessarily limited to the specific features or acts described above. Rather, the specific features and acts described above are disclosed as example embodiments.

Various operations of embodiments are provided herein. The order in which one or more or all of the operations are described should not be construed as to imply that these operations are necessarily order dependent. Alternative ordering will be appreciated based on this description. Further, not all operations may necessarily be present in each embodiment provided herein.

As used in this application, “or” is intended to mean an inclusive “or” rather than an exclusive “or.” Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has,” “with,” or variants thereof are used in either the detailed description or the claims, such terms are intended to be inclusive in a manner similar to the term “comprising”.

Further, unless specified otherwise, “first,” “second,” or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel. Additionally, “comprising,” “comprises,” “including,” “includes,” or the like generally means comprising or including.

Although the disclosure has been shown and described with respect to one or more implementations, equivalent alterations and modifications will occur based on a reading and understanding of this specification and the annexed drawings. The disclosure includes all such modifications and alterations and is limited only by the scope of the following claims.

1. An electronic payment processing system for dynamically selecting a target provider among a set of providers specified by a blockchain distributed database that is remote from the electronic payment processing system, the system comprising:
a processor; and
a memory that stores a block chain interface that comprises a trained machine learning model and executable instructions that, when executed by the processor, perform operations, comprising:
receiving a request for a service, wherein the request is received over an Internet connection and is based on a website that includes the requested service;
traversing, by the block chain interface, the blockchain distributed database, wherein providers in the set of providers that are capable of fulfilling the requested service, wherein traversing by the block chain interface comprises requesting via the processor a bid for the service from each provider in the set of providers;
evaluating, using the trained machine learning model, each provider in the set of providers based on a public ledger that includes respective information associated with each provider, the respective information indicating a service fee offered by the provider based on the provider mining for projected possible transactions on the public ledger, wherein the public ledger is accessible by the set of providers, wherein evaluating each provider comprises:
ranking, by the trained machine learning model, each provider based on meeting or exceeding a predefined parameter related to the requested service, wherein evaluating each provider further comprises ranking each provider, by the trained machine learning model, based on a cost to fulfill the requested service, wherein ranking, by the trained machine learning model, each provider comprises:
inferring how providers should be ranked, and
determining whether a ranked score for each provider is adjusted
based on the predefined parameter related to the requested service;
dynamically selecting, by the trained machine learning model, the target a provider from the set of providers according to the ranking of each service provider, wherein if two providers submit a lowest bid, utilizing, by a selection manager, additional information to select the target provider from the two providers, the additional information comprising: at least one of historical information, current information, and solicited information;
establishing a smart contract with the selected target provider, the smart contract providing for the fulfilment of the requested service,
wherein, establishing the smart contract comprises the system facilitating trade in products or services using the Internet to dynamically contract with a financial entity that is offering the lowest service fee; and
in response to establishing the smart contract with the selected target provider, transmitting the request for the service to the selected target provider to dynamically launch an electronic payment gateway, thereby providing the electronic payment gateway in real-time to a user via the selected target provider.

2. (canceled)

3. (canceled)

4. The system of claim 1, wherein the service is a payment gateway service, the payment gateway is used to purchase one or more items through the website.

5. The system of claim 1, wherein the block chain interface is a transparent, open negotiation platform.

6. The system of claim 5, wherein the block chain interface is accessible by the set of providers.

7. The system of claim 1, wherein the smart contract is pre-negotiated between the selected provider and a host of the website.

8. (canceled)

9. (canceled)

10. The system of claim 1, further comprises fulfilling the service based on an interaction with the selected provider.

11. The system of claim 1, further comprises offering an incentive for a repeat purchase.

12. The system of claim 1, further comprises offering an incentive based on a social network strength.

13. The system of claim 12, the social network strength is based on a quantity of contacts, an activity level, or combinations thereof.

14. The system of claim 12 further comprising:
providing a set of additional incentives based on a first condition that purchases received from members of a defined social network meet or exceed a predetermined threshold; and
removing the incentive based on a second condition that social network strength if purchases received from members of a defined social network fail to meet or exceed the predetermined threshold.

15. A method, comprising:
receiving, by a system comprising a processor, a request for a service from a purchaser, the request is received over an Internet connection and is based on a website that includes the service;
traversing, by the system, a block chain interface that comprises a set of providers, wherein providers in the set of providers are capable of fulfilling the service;
ranking, by the system, each provider in the set of providers based on a public ledger that includes respective information associated with each provider, wherein the information includes the price at which each provider offers its respective service, wherein the at least one parameter is a lowest cost, an availability, or another factor associated with the service;
selecting, by the system, a provider from the set of providers based on the ranking; and
establishing, by the system, a smart contract with the selected provider, the smart contract provides for the fulfilment of the service, requesting, by the system, that an aggregator provide a price recommendation to the purchaser based in part on a review by the aggregator of provider information in the public ledger, sending to the aggregator, from the purchaser, purchase details including price to members of the purchaser's social network, following each transaction the purchaser makes, in exchange for the price recommendations requested by the purchaser from the aggregator, as part of the smart contract between the aggregator and the purchaser.

16. The method of claim 15, further comprises offering, by the system, an incentive based on a determined social network strength of the purchaser, wherein establishing the smart contract is based on an acceptance of the incentive.

17. The method of claim 15, the ranking comprises: determining at least one parameter defined by the purchaser; and
evaluating each provider based on the at least one parameter, wherein the at least one parameter is a lowest cost, an availability, or another factor associated with the service.

18. The method of claim 15, the service is a payment gateway service that is used to purchase one or more items through the website.

19. A non-transitory computer-readable storage device that stores executable instructions that, in response to execution, cause a system comprising a processor to perform operations, comprising:
traversing a block chain interface that comprises a set of providers based on a request for a service, the request is received over an Internet connection and is based on a website that includes the service, and the providers included the set of providers are capable of fulfilling the service;
ranking each provider in the set of providers based on a public ledger that includes respective information associated with each provider;
selecting a provider from the set of providers based on the ranking; and
establishing a smart contract with the selected provider, the smart contract provides for the fulfilment of the service,
wherein the service is a payment gateway service, the payment gateway is used to purchase one or more items through the website,
wherein upon selection of a payment gateway, a financial entity acts as a data miner, mining for projected possible transactions on a merchant account that would allow the financial entity to charge the lowest fees possible.

20. The non-transitory computer-readable storage device of claim 19, the operations further comprise soliciting one or more bids from each provider, wherein the one or more bids are published through the public ledger.
